(19) United States
(12) Patent Application Publication
(10) Pub. No.: US 2019/0324449 A1
(43) Pub. Date: Oct. 24, 2019

(54) SYSTEM AND METHOD FOR SUPPORTING SYNCHRONIZATION IN A MOVABLE PLATFORM

(71) Applicant: SZ DJI TECHNOLOGY CO., LTD., Shenzhen (CN)

(72) Inventors: Xin WANG, Shenzhen (CN); Kang YANG, Shenzhen (CN)

(21) Appl. No.: 16/432,543

(22) Filed: Jun. 5, 2019

Related U.S. Application Data
(63) Continuation of application No. PCT/CN2016/108891, filed on Dec. 7, 2016.

(51) Int. Cl. G05D 1/00; B64C 39/02; G05D 1/08; H04W 56/00

(52) U.S. Cl. CPC G05D 1/0022; B64C 39/024; G05D 1/0808; B64C 2201/127; H04W 56/002; H04W 56/0045; B64C 2201/146; H04W 56/0025

(57) ABSTRACT

A system for supporting synchronization in a movable platform includes a sensing processor associated with one or more sensors and a timing controller associated with a movement controller. The timing controller operates to generate a triggering signal for a sensing operation, generate a timestamp corresponding to the triggering signal, and transmit the triggering signal and the timestamp to the sensing processor. Upon receiving the triggering signal and the timestamp from the movement controller, the sensing processor operates to trigger the sensing operation by the one or more sensors, obtain sensing data of the sensing operation, and associate the timestamp with the sensing data.

### CROSS-REFERENCE TO RELATED APPLICATION

This application is a continuation of International Application No. PCT/CN2016/108891, filed on Dec. 7, 2016, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

The disclosed embodiments relate generally to operating a movable platform and more particularly, but not exclusively, to support synchronization in a movable platform.

### BACKGROUND

Movable platforms such as unmanned aerial vehicles (UAVs) can be used for performing surveillance, reconnaissance, and exploration tasks for military and civilian applications. A movable platform can carry different types of sensors that are capable of sensing the surrounding environment. It is important to able to take advantage of the sensing information obtained from different sources correctly and promptly. This is the general area that embodiments of the disclosure are intended to address.

### SUMMARY

Described herein are systems and methods that provide a technical solution for supporting synchronization in a movable platform. The system comprises a sensing processor associated with one or more sensors and a timing controller associated with a movement controller. The timing controller can generate a triggering signal for a sensing operation and a timestamp corresponding to the triggering signal. Also, the timing controller can transmit the triggering signal and the corresponding timestamp to the sensing processor. Upon receiving the triggering signal and the corresponding timestamp from the movement controller, the sensing processor can trigger the sensing operation by the one or more sensors, obtain sensing data of the triggered sensing operation, and associate the received timestamp with the sensing data.

### BRIEF DESCRIPTION OF DRAWINGS

FIG. 1 illustrates a movable platform environment, in accordance with various embodiments of the present disclosure.

FIG. 2 illustrates an exemplary carrier in a movable platform environment, in accordance with embodiments.

FIG. 3 illustrates an exemplary computing architecture for a movable platform, in accordance with various embodiments.

FIG. 4 shows an exemplary illustration of supporting synchronization in a movable platform, in accordance with various embodiments of the present disclosure.

FIG. 5 shows another exemplary illustration of synchronization in a movable platform, in accordance with various embodiments of the present disclosure.

FIG. 6 shows an exemplary illustration of supporting synchronization in another alternative movable platform, in accordance with various embodiments of the present disclosure.

FIG. 7 shows an exemplary illustration of controlling movement of an unmanned aerial vehicle (UAV) based on data fusion, in accordance with various embodiments of the present disclosure.

FIG. 8 shows a flowchart of supporting synchronization in a movable platform using a movement controller, in accordance with various embodiments of the present disclosure.

FIG. 9 shows a flowchart of supporting synchronization in a movable platform using a timing controller associated with a movement controller, in accordance with various embodiments of the present disclosure.

FIG. 10 shows a flowchart of supporting synchronization in a movable platform using a sensing processor, in accordance with various embodiments of the present disclosure.

FIG. 11 shows a flowchart of supporting synchronization in a movable platform using an application processor, in accordance with various embodiments of the present disclosure.

FIG. 12 shows a flowchart of supporting synchronization in a UAV, in accordance with various embodiments of the present disclosure.

### DETAILED DESCRIPTION

The disclosure is illustrated, by way of example and not by way of limitation, in the figures of the accompanying drawings in which like references indicate similar elements. It should be noted that references to “an” or “one” or “some” embodiment(s) in this disclosure are not necessarily to the same embodiment, and such references mean at least one.

The description of the disclosure as following uses an unmanned aerial vehicle (UAV) as example for a movable platform. It will be apparent to those skilled in the art that other types of movable platform can be used without limitation.

In accordance with various embodiments of the present disclosure, the system can provide a technical solution for supporting synchronization in a movable platform. The system comprises a sensing processor associated with one or more sensors and a timing controller associated with a movement controller. The timing controller can generate a triggering signal for a sensing operation and a timestamp corresponding to the triggering signal. Also, the timing controller can transmit the triggering signal and the corresponding timestamp to the sensing processor. Upon receiving the triggering signal and the corresponding timestamp from the movement controller, the sensing processor can trigger the sensing operation by the one or more sensors, obtain sensing data of the triggered sensing operation, and associate the received timestamp with the sensing data.

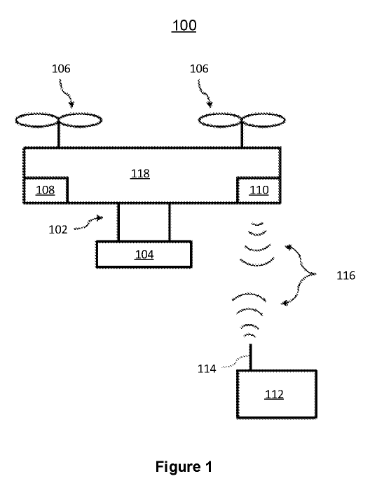

FIG. 1 illustrates a movable platform environment, in accordance with various embodiments of the present disclosure. As shown in FIG. 1, a movable platform 118 (also referred to as a movable object) in a movable platform environment 100 can include a carrier 102 and a payload 104. Although the movable platform 118 can be depicted as an aircraft, this depiction is not intended to be limiting, and any suitable type of movable platform can be used. One of skill in the art would appreciate that any of the embodiments described herein in the context of aircraft systems can be applied to any suitable movable platform (e.g., a UAV). In some instances, the payload 104 may be provided on the movable platform 118 without requiring the carrier 102.

In accordance with various embodiments of the present disclosure, the movable platform 118 may include one or more movement mechanisms 106 (e.g. propulsion mechanisms), a sensing system 108, and a communication system 110.

The movement mechanisms 106 can include one or more of rotors, propellers, blades, engines, motors, wheels, axles, magnets, nozzles, or any mechanism that can be used by animals, or human beings for effectuating movement. For example, the movable platform may have one or more propulsion mechanisms. The movement mechanisms 106 may all be of the same type. Alternatively, the movement mechanisms 106 can be different types of movement mechanisms. The movement mechanisms 106 can be mounted on the movable platform 118 (or vice-versa), using any suitable means such as a support element (e.g., a drive shaft). The movement mechanisms 106 can be mounted on any suitable portion of the movable platform 118, such on the top, bottom, front, back, sides, or suitable combinations thereof.

In some embodiments, the movement mechanisms 106 can enable the movable platform 118 to take off vertically from a surface or land vertically on a surface without requiring any horizontal movement of the movable platform 118 (e.g., without traveling down a runway). Optionally, the movement mechanisms 106 can be operable to permit the movable platform 118 to hover in the air at a specified position and/or orientation. One or more of the movement mechanisms 106 may be controlled independently of the other movement mechanisms. Alternatively, the movement mechanisms 106 can be configured to be controlled simultaneously. For example, the movable platform 118 can have multiple horizontally oriented rotors that can provide lift and/or thrust to the movable platform. The multiple horizontally oriented rotors can be actuated to provide vertical takeoff, vertical landing, and hovering capabilities to the movable platform 118. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable platform 118 (e.g., with respect to up to three degrees of translation and up to three degrees of rotation).

The sensing system 108 can include one or more sensors that may sense the spatial disposition, velocity, and/or acceleration of the movable platform 118 (e.g., with respect to various degrees of translation and various degrees of rotation). The one or more sensors can include any of the sensors, including GPS sensors, motion sensors, inertial sensors, proximity sensors, or image sensors. The sensing data provided by the sensing system 108 can be used to control the spatial disposition, velocity, and/or orientation of the movable platform 118 (e.g., using a suitable processing unit and/or control module). Alternatively, the sensing system 108 can be used to provide data regarding the environment surrounding the movable platform, such as weather conditions, proximity to potential obstacles, location of geographical features, location of manmade structures, and the like.

The communication system 110 enables communication with terminal 112 having a communication system 114 via wireless signals 116. The communication systems 110, 114 may include any number of transmitters, receivers, and/or transceivers suitable for wireless communication. The communication may be one-way communication, such that data can be transmitted in only one direction. For example, one-way communication may involve only the movable platform 118 transmitting data to the terminal 112, or vice-versa. The data may be transmitted from one or more transmitters of the communication system 110 to one or more receivers of the communication system 114, or vice-versa. Alternatively, the communication may be two-way communication, such that data can be transmitted in both directions between the movable platform 118 and the terminal 112. The two-way communication can involve transmitting data from one or more transmitters of the communication system 110 to one or more receivers of the communication system 114, and vice-versa.

In some embodiments, the terminal 112 can provide control data to one or more of the movable platform 118, carrier 102, and payload 104 and receive information from one or more of the movable platform 118, carrier 102, and payload 104 (e.g., position and/or motion information of the movable platform, carrier or payload; data sensed by the payload such as image data captured by a payload camera; and data generated from image data captured by the payload camera). In some instances, control data from the terminal may include instructions for relative positions, movements, actuations, or controls of the movable platform, carrier, and/or payload. For example, the control data may result in a modification of the location and/or orientation of the movable platform (e.g., via control of the movement mechanisms 106), or a movement of the payload with respect to the movable platform (e.g., via control of the carrier 102). The control data from the terminal may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view).

In some instances, the communications from the movable platform, carrier and/or payload may include information from one or more sensors (e.g., of the sensing system 108 or of the payload 104) and/or data generated based on the sensing information. The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable platform, carrier, and/or payload. Such information from a payload may include data captured by the payload or a sensed state of the payload. The control data transmitted by the terminal 112 can be configured to control a state of one or more of the movable platform 118, carrier 102, or payload 104. Alternatively or in combination, the carrier 102 and payload 104 can also each include a communication module configured to communicate with terminal 112, such that the terminal can communicate with and control each of the movable platform 118, carrier 102, and payload 104 independently.

In some embodiments, the movable platform 118 can be configured to communicate with another remote device in addition to the terminal 112, or instead of the terminal 112. The terminal 112 may also be configured to communicate with another remote device as well as the movable platform 118. For example, the movable platform 118 and/or terminal 112 may communicate with another movable platform, or a carrier or payload of another movable platform. When desired, the remote device may be a second terminal or other computing device (e.g., computer, laptop, tablet, smartphone, or other mobile device). The remote device can be configured to transmit data to the movable platform 118, receive data from the movable platform 118, transmit data to the terminal 112, and/or receive data from the terminal 112. Optionally, the remote device can be connected to the Internet or other telecommunications network, such that data received from the movable platform 118 and/or terminal 112 can be uploaded to a website or server.

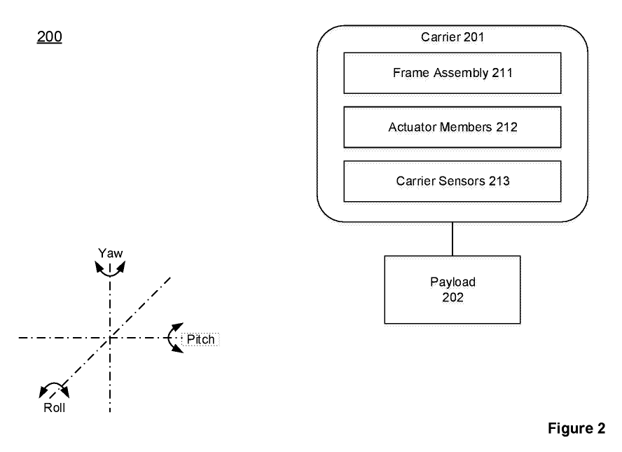

FIG. 2 illustrates an exemplary carrier in a movable platform environment 200, in accordance with embodiments. The carrier 201 can be used to couple a payload 202 such as an image capturing device to a movable platform such as a UAV.

The carrier 201 can be configured to permit the payload 202 to rotate about one or more axes, such as three axes: X or pitch axis, Z or roll axis, and Y or yaw axis, relative to the movable platform. For instance, the carrier 201 may be configured to permit the payload 202 to rotate only around one, two, or three of the axes. The axes may or may not be orthogonal to each other. The range of rotation around any of the axes may or may not be limited and may vary for each of the axes. The axes of rotation may or may not intersect with one another. For example, the orthogonal axes may intersect with one another. They may or may not intersect at a payload 202. Alternatively, they may not intersect.

The carrier 201 can include a frame assembly 211 comprising one or more frame members. For example, a frame member can be configured to be coupled with and support the payload 202 (e.g., image capturing device).

In some embodiments, the carrier 201 can comprise one or more carrier sensors 213 useful for determining a state of the carrier 201 or the payload 202 carried by the carrier 201. The state information may include a spatial disposition (e.g., position, orientation, or attitude), a velocity (e.g., linear or angular velocity), an acceleration (e.g., linear or angular acceleration), and/or other information about the carrier, a component thereof, and/or the payload 202. In some embodiments, the state information as acquired or calculated from the sensor data may be used as feedback data to control the rotation of the components (e.g., frame members) of the carrier. Examples of such carrier sensors may include motion sensors (e.g., accelerometers), rotation sensors (e.g., gyroscope), inertial sensors, and the like.

The carrier sensors 213 may be coupled to any suitable portion or portions of the carrier (e.g., frame members and/or actuator members) and may or may not be movable relative to the UAV. Additionally or alternatively, at least some of the carrier sensors may be coupled directly to the payload 202 carried by the carrier 201.

The carrier sensors 213 may be coupled with some or all of the actuator members of the carrier. For example, three carrier sensors can be respectively coupled to the actuator members 212 for a three-axis carrier and configured to measure the driving of the respective actuator members 212 for the three-axis carrier. Such sensors can include potentiometers or other similar sensors. In an embodiment, a sensor (e.g., potentiometer) can be inserted on a motor shaft of a motor so as to measure the relative position of a motor rotor and motor stator, thereby measuring the relative position of the rotor and stator and generating a position signal representative thereof. In an embodiment, each actuator-coupled sensor is configured to provide a positional signal for the corresponding actuator member that it measures. For example, a first potentiometer can be used to generate a first position signal for the first actuator member, a second potentiometer can be used to generate a second position signal for the second actuator member, and a third potentiometer can be used to generate a third position signal for the third actuator member. In some embodiments, carrier sensors 213 may also be coupled to some or all of the frame members of the carrier. The sensors may be able to convey information about the position and/or orientation of one or more frame members of the carrier and/or the image capturing device. The sensor data may be used to determine position and/or orientation of the image capturing device relative to the movable platform and/or a reference frame.

The carrier sensors 213 can provide position and/or orientation data that may be transmitted to one or more controllers (not shown) on the carrier or movable platform. The sensor data can be used in a feedback-based control scheme. The control scheme can be used to control the driving of one or more actuator members such as one or more motors. One or more controllers, which may be situated on a carrier or on a movable platform carrying the carrier, can generate control signals for driving the actuator members. In some instances, the control signals can be generated based on data received from carrier sensors indicative of the spatial disposition of the carrier or the payload 202 carried by the carrier 201. The carrier sensors may be situated on the carrier or the payload 202, as previously described herein. The control signals produced by the controllers can be received by the different actuator drivers. Based on the control signals, the different actuator drivers may control the driving of the different actuator members, for example, to effect a rotation of one or more components of the carrier. An actuator driver can include hardware and/or software components suitable for controlling the driving of a corresponding actuator member and receiving position signals from a corresponding sensor (e.g., potentiometer). The control signals can be transmitted simultaneously to the actuator drivers to produce simultaneous driving of the actuator members. Alternatively, the control signals can be transmitted sequentially, or to only one of the actuator drivers. Advantageously, the control scheme can be used to provide feedback control for driving actuator members of a carrier, thereby enabling more precise and accurate rotation of the carrier components.

In some instances, the carrier 201 can be coupled indirectly to the UAV via one or more damping elements. The damping elements can be configured to reduce or eliminate movement of the load (e.g., payload, carrier, or both) caused by the movement of the movable platform (e.g., UAV). The damping elements can include any element suitable for damping motion of the coupled load, such as an active damping element, a passive damping element, or a hybrid damping element having both active and passive damping characteristics. The motion damped by the damping elements provided herein can include one or more of vibrations, oscillations, shaking, or impacts. Such motions may originate from motions of the movable platform that are transmitted to the load. For example, the motion may include vibrations caused by the operation of a propulsion system and/or other components of a UAV.

The damping elements may provide motion damping by isolating the load from the source of unwanted motion by dissipating or reducing the amount of motion transmitted to the load (e.g., vibration isolation). The damping elements may reduce the magnitude (e.g., amplitude) of the motion that would otherwise be experienced by the load. The motion damping applied by the damping elements may be used to stabilize the load, thereby improving the quality of images captured by the load (e.g., image capturing device), as well as reducing the computational complexity of image stitching steps required to generate a panoramic image based on the captured images.

The damping elements described herein can be formed from any suitable material or combination of materials, including solid, liquid, or gaseous materials. The materials used for the damping elements may be compressible and/or deformable. For example, the damping elements can be made of sponge, foam, rubber, gel, and the like. For example, damping elements can include rubber balls that are substantially spherical in shape. The damping elements can be of any suitable shape such as substantially spherical, rectangular, cylindrical, and the like. Alternatively or in addition, the damping elements can include piezoelectric materials or shape memory materials. The damping elements can include one or more mechanical elements, such as springs, pistons, hydraulics, pneumatics, dashpots, shock absorbers, isolators, and the like. The properties of the damping elements can be selected so as to provide a predetermined amount of motion damping. In some instances, the damping elements may have viscoelastic properties. The properties of the damping elements may be isotropic or anisotropic. For instance, the damping elements may provide motion damping equally along all directions of motion. Conversely, the damping element may provide motion damping only along a subset of the directions of motion (e.g., along a single direction of motion). For example, the damping elements may provide damping primarily along the Y (yaw) axis. As such, the illustrated damping elements can be configured to reduce vertical motions.

Although various embodiments may be depicted as utilizing a single type of damping elements (e.g., rubber balls), it shall be understood that any suitable combination of types of damping elements can be used. For example, the carrier may be coupled to the movable platform using one or more damping elements of any suitable type or types. The damping elements may have the same or different characteristics or properties such as stiffness, viscoelasticity, and the like. Each damping element can be coupled to a different portion of the load or only to a certain portion of the load. For instance, the damping elements may be located near contact or coupling points or surfaces of between the load and the movable platforms. In some instances, the load can be embedded within or enclosed by one or more damping elements.

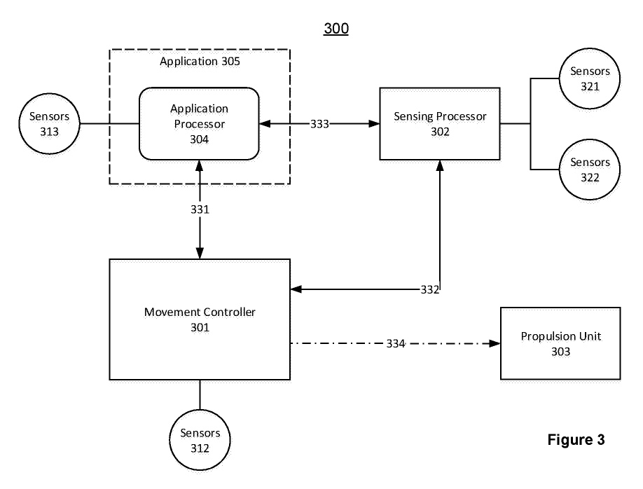

FIG. 3 illustrates an exemplary computing architecture for a movable platform, in accordance with various embodiments. The movable platform 300 (e.g. a UAV) can comprise one or more processing modules (which may also be referred to as processing units, system, subsystems, or processors). As shown in FIG. 3, the movable platform 300 can comprise a movement controller 301, a real-time sensing processor 302, and an application processor 304. In some instances, the movable platform 300 may comprise alternative and/or additional types of processing modules. For example, the movable platform 300 can comprise an image processor, an image transmission module, and/or other processing modules.

In accordance with various embodiments, multiple processing modules can be provided for managing the movement of the movable platform 300. Any combination or variation of the processing modules may be provided. For example, a UAV may comprise a real-time sensing processor 302 and a movement controller 301. In another example instances, the UAV may comprise an application processor 304 and a movement controller 301.

In accordance with various embodiments, the processing modules can be implemented using a heterogeneous system, such as a system on chip (SOC) system. The SOC system can be an integrated circuit (IC) that integrates various computational components into a single chip. It can contain digital, analog, mixed-signal, and other functional circuits on a single chip substrate. The SOC system is capable of running various types of application software that can be beneficial for performing complex tasks. Also, the SOC system can provide a high degree of chip integration, which can potentially lead toward reduced manufacturing costs and smaller footprint. Alternatively, the heterogeneous system can be a system in package (SiP), which contains a number of chips in a single package.

In accordance with various embodiments, the processing modules can be provided on-board the movable platform 300. Alternatively or in addition, some of the processing modules may be provided off-board the movable platform 300 (e.g., at a ground terminal for a UAV). In some instances, each of the processing modules may be a circuit unit or a portion of a circuit unit (e.g. a single core in a chip or a chip system). Alternatively or additionally, each of the processing modules can be a single core or multi-core chip (or a chip system). In some instances, various processing modules may be provided on the same or different printed circuit boards (PCBs).

In accordance with various embodiments, the movement controller 301 (e.g. a flight controller on a UAV) can be configured to effect functionalities or features of the movable platform 300, e.g., by controlling one or more propulsion units 303 via a connection 334. For example, a movement controller on a UAV can affect or control the movement of the UAV such that various navigation features can be implemented. In some instances, the movement controller can receive instructions or information from other processors (or processing modules) such as the application processor and/or sensing processor. In some instances, the movement controller can be configured to process information (e.g., information received from sensors coupled to the movement controller) to maintain a stable flight of the UAV. In some instances, the movement controller may be sufficient to maintain the UAV in the air, e.g., without the involvement of other processors or processing modules such as the application processor and/or the real-time sensing processor. For example, in the event of a failure of the application processor and/or the real-time sensing processor, the movement controller can prevent a complete failure or crashing of the UAV.

In accordance with various embodiments, the movement controller 301 can be configured to process data in real time and with high reliability. This can be beneficial for controlling movement of the movable platform 300. For example, based on the data received from various sources (e.g., from the application processor, the real-time processor, and/or one or more sensors coupled to the movement controller), the movement controller can control the flight of a UAV by sending flight control instructions to one or more electronic speed control (ESC) controllers. The ESC controllers can be configured to precisely and efficiently control the operation of motors coupled to one or more propulsion units 303 of the UAV, thereby affecting the actual flight of the UAV. For example, the movement controller may be responsible for the flight of the UAV, since the application processor and/or the real-time sensing processor may not be directly coupled to the ESC controllers (i.e., the application processor and/or the real-time sensing processor may not generate or send instructions for controlling ESC controllers directly).

In some instances, the application processor 304 can manage the navigation and operation of the movable platform 300. For example, the application processor 304 may comprise a central processing unit (CPU). Alternatively or in addition, the application processor 304 may comprise a graphical processing unit (GPU). The GPU may be a dedicated GPU. Alternatively, the GPU may be an integrated GPU on a same die as the CPU (i.e. in a SOC system). The CPU and/or the GPU may provide powerful computing capacity to the application processor 304 such that the application processor 304 is able to process data or accomplish tasks requiring high processing power (e.g., computer vision computing). For example, the application processor 304 may alternatively or additionally be responsible for encoding data, providing a secure environment for the UAV system (e.g., system image), updating the UAV system, and/or providing system interoperability with other peripheral devices or processing modules. In some instances, the application processor 304 may be responsible for managing other peripheral devices or processing modules and/or processing data from other devices or modules.

In some instances, the application processor 304 may be configured to run an operating system. The operating system may be a general purpose operating system configured to run a plurality of programs and applications 305, depending on mission requirements or user preference. In some instances, the applications 305 running on the application processor 304 may relate to flight and/or control of the UAV. In some instances, external devices coupled to the application processor 304 (e.g., via various interfaces provided) may load programs or applications that can be executed on the application processor 304. For example, the applications running on the application processor 304 can perform visual sensing, tracking, and video processing. In some instances, applications running on the movable platform 300 can be user configurable and/or updatable. Accordingly, the operating system may provide a means to update and/or add functionality to the movable platform 300. In some instances, the operational capabilities of the movable platform 300 may be updated or increased with no hardware upgrades. In some instances, the operational capabilities of the movable platform 300 may be updated or increased with a software update via the operating system. In some instances, the operating system may be a non-real time operating system. Alternatively, the operating system may be a real-time operating system. A real time operating system may be configured to respond to input (e.g., input data) instantly and consistently with very short or no system delay (i.e. in real time). On the other hand, a non-real time operating system may respond to input with some delay.

In some instances, the application processor 304 can provide, or be responsible for, security of the movable platform 300. For example, a UAV system can prevent resources of importance from being copied, damaged, or made available to unauthorized users. Authorized users may include owners and/or other authorized operators of the UAV. In some instances, the UAV system can ensure that the UAV remains stable and responsive to commands from an authorized user. Also, the UAV system may prevent unauthorized users (or non-genuine users, e.g., hackers) from compromising the UAV system.

In accordance with various embodiments, a system image of the movable platform 300 may comprise a complete state of the movable platform 300 system. In some instances, the system image of the movable platform 300 may comprise the state of the application processor 304 (e.g., operating system state), and the states of other processors or processing modules and/or other components of the movable platform 300 system. The application processor 304 may provide security via software (e.g., applications running on the operating system). For example, the operating system running on the application processor 304 may provide security solutions for the movable platform 300. In some instances, the application processor 304 may provide security via hardware security measures, e.g. a hardware security key. In some instances, a combination of integrated hardware and software components may provide security to the movable platform 300 system.

In some instances, the application processor 304 can be configured to verify a validity of the system image when the movable platform 300 is powering up. Alternatively or in addition, the application processor 304 can be configured to verify a validity of the system image when a payload (e.g., primary imaging sensor) of the UAV is powering up. Alternatively or in addition, a system image of the UAV may be verified at predetermined intervals. For example, the system image may be configured to be verified by the application processor 304 about or more frequently than every 6 months, every 3 months, every month, every 2 weeks, every week, every 3 days, every 24 hours, every 12 hours, every 6 hours, every 3 hours, or every hour.

In some instances, the movable platform 300 can verify the validity of the system image. The application processor 304 may be configured to verify the validity of a system image, e.g. with aid of the key burned into a micro fuse. In some instances, only verified system images may be allowed to start up. For example, an operating system of the UAV or the application processor 304 may not be allowed to start up prior to the verification of the system image. In some instances, the application processor 304 can be further configured to verify and record a login information of a user in the secure environment before flight of the UAV is allowed.

In some instances, the application processor 304 can enable safe system upgrading. For example, in order to upgrade the movable platform 300, different processing modules can receive the upgraded system image from the application processor. Thus, the processing modules can proceed to upgrade the system image. In some instances, the processing modules may be configured to receive the system image from the application processor 304. In some instances, these processing modules may further be configured to verify the validity of the received image. In some instances, these processing modules may verify the validity of received images using respective private keys. For example, the movement controller may prevent the UAV from taking off prior to verifying the validity of the imaging system by the application processing module, and/or other processing modules such as the real-time sensing processor.

In some instances, the application processor 304 can be configured to receive data from an imaging sensor and store the data in a secure environment. In some instances, the application processor 304 can be further configured to encrypt the data (e.g., image data) before transmitting the data to a storage medium. In some instances, the encrypted data may be decrypted only by appropriate users. In some instances, the appropriate user is an operator of the UAV or an owner of the UAV. Alternatively or in addition, the appropriate user may comprise authorized users who may have been granted permission.

In some instances, the movable platform 300 can comprise a sensing processor 302, e.g. a real-time sensing processor. The sensing processor 302 can comprise a visual processor and/or a digital signal processor. The sensing processor 302 can provide powerful image processing capabilities and may operate in real-time or close to real-time. In some instances, a real-time sensing processor can process data from one or more sensors 321-322 to obtain a height measurement (e.g., height of the UAV relative to a ground) or a speed measurement (e.g., speed of the UAV). In some instances, the real-time sensing processor can process data from the one or more sensors and be responsible for obstacle detection and depth map calculation. In some instances, the real-time sensing processor may process information from various processing modules and oversee data fusion of sensor data such that more accurate information regarding a state of the UAV can be ascertained. For example, the real-time sensing processor may process sensor information received from a movement controller.

In some instances, various processing modules can be configured to manage different operational aspects of the movable platform 300 to enable an efficient use of resources. In some instances, the real-time sensing processor may process data collected from real time sensing, the application processor may process data using various application logics, which can be dynamic and complex, and the movement controller may affect movement based on data from the different processing modules or from sensors coupled to the movement controller. For example, the application processor 304 can perform computationally intensive tasks or operations, while the real time sensing processor may act as a support and ensure optimal operation (e.g., stable operation) of the UAV by processing sensor data in real time.

In accordance with various embodiments, the movable platform 300 can provide a computer vision system on various processing modules. Through processing digital images or videos, the computer vision system can determine positioning information, reconstruct scenes, search and identify matching images or videos in existing data. The computer vision system tends to consume significant computing power and requires large physical footprint. Yet implementing a computer vision system in a compact environment has a broad appeal. For example, an onboard computer vision system in a UAV may process images/videos captured by camera(s) to make real-time decisions to guide the UAV. For example, the UAV may determine how to navigate, avoiding obstacles identified by the computer vision system. Additionally, the UAV may determine whether to adjust an onboard camera (e.g., zoom-in or zoom-out) based on the determination of whether the obtained images/videos are for the target. Also, the UAV may determine whether to drop a parcel based on the determination of whether the position/surrounding of a location of the movable object is the expected parcel destination.

In some instances, various processing modules can be configured to perform sensor data fusion. Based on information obtained from one or more sensors 312 coupled to the movement controller 301 and/or information obtained from the real-time sensing processor 302 or one or more sensors 313 coupled to the application processor 304, the movement controller 301 can govern the actual movement of the movable platform 300 by adjusting the propulsion unit 303. For example, a movement controller for a UAV can maintain the UAV in stable flight even when other processing modules (e.g., the application processor or the real-time sensing processor) fail. For example, based on attitude data obtained from one or more IMU sensors coupled to the movement controller and vision data obtained by the real-time vision processor, a movement controller can perform data fusion such that accurate information regarding a state of the UAV can be ascertained.

In accordance with various embodiments, the processing modules can be configured to communicate with one another. The flow of information or data may be in any direction between the different processing modules. For example, data may flow from the real-time sensing processor to the application processor and/or the movement controller. Alternatively or in addition, data or information may flow from the application processor to the movement controller and/or the real time sensing processor. Alternatively or in addition, data or information may flow from the movement controller to the real-time sensing processor and/or the application processor.

The ability for the different processing modules to communicate (e.g., directly communicate) with one another (e.g. via communication connections 331-333) allows a subset of the processing modules to accomplish a task or process data in an efficient manner best suited for a given operation of the UAV. Utilizing different processing modules (e.g., the aforementioned application processor, real-time sensing processor, and movement controller) and enabling direct communication between the modules can enable the coupling of sensors, controllers, and devices to the different processing modules such that the flight of a UAV can be managed in an efficient manner where suited processing modules can take care of different operational aspects of the UAV. In some instances, the direct coupling between components can reduce communication latency and ensure system consistency and reliability.

In accordance with various embodiments, the movable platform 300 may provide a plurality of interfaces for coupling, or connecting, to peripheral devices. The interfaces may be any type of interface and may include, but are not limited to USB, UART, I2C, GPIO, I2S, SPI, MIPI, HPI, HDMI, LVDS, and the like. The interface may be configured with a number of characteristics. For example, the interface may be configured with characteristics such as a bandwidth, latency, and/or throughput. In some instances, the peripheral devices may comprise additional sensors and/or modules. The peripheral devices may be coupled to the application processing module via specific interfaces depending on needs (e.g., bandwidth or throughput needs). In some instances, a high bandwidth interface (e.g., MIPI) may be utilized where high bandwidth is necessary (e.g., image data transmission). In some instances, a low bandwidth interface (e.g., UART) may be utilized where low bandwidth is acceptable (e.g., control signal communication).

The interfaces can provide modularity to the movable platform 300 such that a user may update peripheral devices depending on mission requirements or preference. For example, depending on a user's needs and mission objectives, peripheral devices may be added or swapped in and out to enable a modular configuration that is best suited for the movable platform 300 objective. In some instances, the plurality of interfaces may easily be accessible by a user. In some instances, the plurality of interfaces may be located within a housing of the movable platform 300. Alternatively or in addition, the plurality of interfaces may be located in part, on an exterior of the movable platform 300.

In some instances, the application processor 304 can manage and/or interact with various peripheral devices, sensors, and/or other processors. The application processor 304 may communicate with the real-time sensing processor 302 and/or the movement controller 301 for efficient processing of data and implementation of UAV features. In some instances, the application processor 304 can receive data or information from any or all of the other processing modules and further process the data or information to generate useful information for managing the movement of the movable platform 300 (e.g., building grid map for obstacle avoidance). In some instances, the application processor 304 can ensure that different programs, input, and/or data are efficiently divided up and processed by different processing modules. In some instances, the operating system running on the application processor 304, as well as the various interfaces which enable an operator of the movable platform 300 to configure the movable platform 300 to operate with updated applications and/or devices (e.g., peripherals) may provide the UAV great modularity and configurability such that the UAV is able to operate under conditions best suited for a given mission objective.

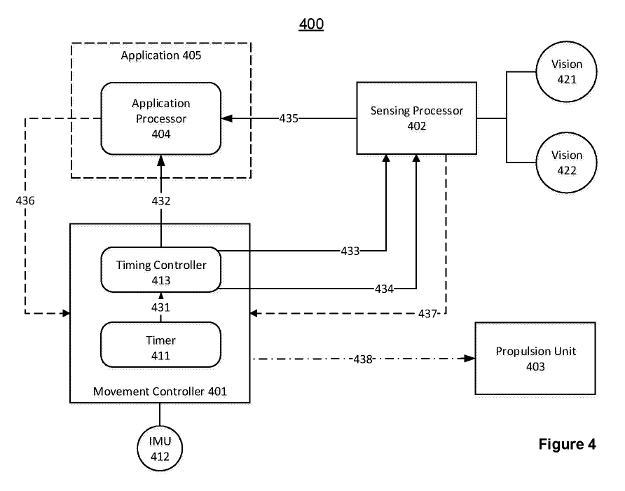

FIG. 4 shows an exemplary illustration of supporting synchronization in a movable platform, in accordance with various embodiments of the present disclosure. As shown in FIG. 4, a movement controller 401 can be used for controlling the movement of a movable platform 400 (e.g. a UAV). Furthermore, the movable platform 400 can use a sensing processor 402 for sensing the environment. For example, the sensing processor 402 can be a vision processor, e.g. a vision processing unit (VPU), which can process images of the environment captured by various vision sensors 421-422.

In accordance with various embodiments, system time can be maintained using different processing modules on the movable platform 400. As shown in FIG. 4, the movable platform 400 can maintain a system time based on a timer 411. For example, the timer 411 can generate clock signals representing the current system time for various circuit components. Alternatively, the timer 411 can be a counter that outputs a signal when it reaches a predetermined count. In some instances, the timer 411 can be configured and/or provided by the movement controller 401. By maintaining the system time locally, the movement controller 401 can ensure that the system time is reliable and precise, which can be beneficial for performing various mission critical tasks. For example, a movement controller can maintain the attitude and position of a UAV in the air, by synchronizing the various movement characteristic information (such as the translational acceleration and rotation speed of the UAV) measured by an inertia measurement unit (IMU) with measurements of the environment by other sensors (e.g. at the same time point or at different time points).

Alternatively, the system time can be configured based on a timing mechanism on the application processor 404 on the movable platform 400. For example, a timer 411 can be configured and/or provided on the application processor 404, which can manage the navigation and operation of the movable platform 400. By maintaining system time using the application processor 404, an application 405 running on the application processor 404 can conveniently synchronize mission data with sensing data received from different sources (e.g. data collected from different sensors associated with the movable platform 400). Alternatively, the system time can be configured based on a timing mechanism on the sensing processor 402 or any other processing modules on the movable platform 400, for various purposes.

In accordance with various embodiments, the movement controller 401 can generate a triggering signal. Also, the movement controller 401 can generate a timestamp corresponding to the triggering signal, based on a maintained system time.

As shown in FIG. 4, a timing controller 413 in the movement controller 401 can generate a triggering signal (e.g. an exposure signal) in a predetermined frequency based on a timing signal (according to configured system time) provided by the timer 411. For example, the triggering signal can be a software/hardware interrupt signal. Furthermore, the timing controller 413 can latch the timing signal 431 to generate a timestamp corresponding to the triggering signal, e.g. at the time when the triggering signal is generated. Alternatively, a timestamp can be generated for indicating a predetermined future time point, when multiple sensing operations can be performed simultaneously. For example, the timing controller 413, which comprises a functional circuit unit, can obtain a sequence number associated with the latched timing signal. Then, the timing controller 413 can save the timestamp corresponding to the triggering signal.

In accordance with various embodiments, the triggering signal can be generated at a predetermined frequency. For example, the movement controller can generate an exposure signal for capturing images via the vision sensors 421-422 at a frequency that satisfies the need for controlling a UAV. In some instances, the frequency for generating the exposure signal can be determined or configured to enable data fusion of vision data with the movement characteristic data collected by the IMU 412. For example, a movement controller for a UAV can generate an exposure signal about or more frequently than every hour, every minute, every thirty seconds, every twenty seconds, every ten seconds, every five seconds, every two seconds, or every second. Or, in every second, a movement controller for a UAV can generate about one, two, five, ten, twenty, thirty, fifty, one hundred, two hundreds, three hundreds, five hundreds, one thousand or more exposure signals.

Furthermore, the timing controller 413 can provide the exposure signal 433 and the timestamp 434 to the sensing processor 402 to trigger the capturing of one or more images by the vision sensors 421-422. In the meantime, the timing controller 413 can provide the timestamp 432 to the application processor 304 and other processing modules on the movable platform 400.

In accordance with various embodiments, the movement controller 401 can transmit the exposure signal 433 and the corresponding timestamp 434 to the sensing processor 402, e.g. via a signal line. Additionally or optionally, the timing controller 413 can encode the timestamp before transmitting the timestamp information to the sensing processor 402. Various encoding scheme can be used for encoding the timestamp. For example, the timestamp can be transmitted together with the triggering signal. Alternatively, the timestamp and the triggering signal can be transmitted separately. Once the sensing processor receives the encoded timestamp, the sensing processor 402 can decode the received timestamp information to obtain the timestamp.

In accordance with various embodiments, upon receiving the triggering signal and the corresponding timestamp from the movement controller 401, the sensing processor 402 can trigger the sensing operation by one or more sensors 421-422. Then, the sensing processor 402 can obtain sensing data of the triggered sensing operation, and associate the received timestamp with the sensing data. For example, the timestamp can be included in a header section for the sensing data.

In accordance with various embodiments, the sensing processor 402 can further process the collected sensing information of the surrounding environment. For example, the sensing processor 402 can trigger the one or more vision sensors 421-422 to capture one or more images, which can be used for computing a depth map or performing visual odometry that is useful for positioning, mapping, and obstacle avoidance.

In accordance with various embodiments, the sensing processor 402 can communicate the sensing data with other processing modules on the movable platform 400 via a connection 435 (e.g. a memory bus). For example, the sensing processor 402 can write the captured imaging information and/or processed information, such as the vision data applied with the timestamp, into a double data rate synchronous dynamic random-access memory (DDR DRAM) via the memory bus. Additionally, the sensing processor 402 can provide the memory address to the application processor 404. Then, the application processor 404 can obtain the vision data, which is applied with the timestamp, from the corresponding memory block in the DDR DRAM, via the memory bus. Thus, the sensing processor 402 can efficiently transmit a large quantity of vision data to the application processor 404.

In accordance with various embodiments, the application processor 404 can make determinations on UAV task management and navigation control. In some instances, the application processor 404 can receive sensing information from the sensors (including sensors associated with other processing modules, e.g. IMU sensors 412 on the movement controller 401). In some instances, data from the other sensors may be collected at a time point that is different from the time point when the vision data is captured. Based on the timestamp difference, the application processor 404 can perform data fusion using various technique to synchronize the collected sensing information, e.g. modifying the collected sensing data to adjust for the time difference. Alternatively, data from the other sensors may be collected at a time point that is the same as the time point when the vision data is captured, e.g. at a predetermined time point. Thus, based on the synchronized information, the application processor 404 can apply various application logics, such as planning a complex navigation route for performing multiple tasks simultaneously (e.g. tracking a target while performing obstacle avoidance, and provide such determination to the movement controller 401).

Then, the application processor 404 can provide the determination to the movement controller 401 via a connection 436. Alternatively, the sensing processor 402 can send the sensing data to the movement controller 401 via a connection 437, which in turn can make the determination. Thus, the movement controller 401 can generate control signals for controlling one or more propulsion units 403 based on such determination, and transmit the control signal 438 to the propulsion unit 403. For example, a movement controller for a UAV can generate signals to electronic speed controls (ESCs) for controlling the movement of the UAV, via controlling the operation of the propellers. In some instances, an ESC is an electronic circuit with the purpose to vary an electric motor's speed.

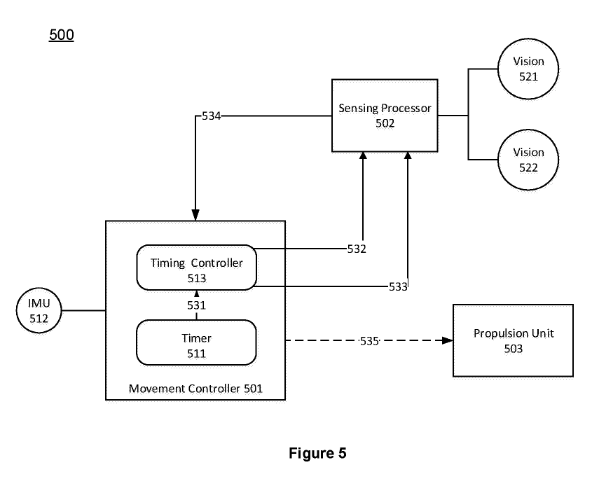

FIG. 5 shows another exemplary illustration of synchronization in a movable platform, in accordance with various embodiments of the present disclosure. As shown in FIG. 5, a movement controller 501 can be used for controlling the movement of a movable platform 500 (e.g. a UAV). Furthermore, the movable platform 500 can use a sensing processor 502 for processing information from the environment. For example, the sensing processor 502 can be a vision processor, e.g. a vision processing unit (VPU), which can process images of the environment captured by various vision sensors 521-522.

In accordance with various embodiments, system time can be maintained using different processing modules on the movable platform 500. As shown in FIG. 5, the movable platform 500 can maintain a system time based on a timer 511. In some instances, the timer 511, which is configured and/or provided on the movement controller 501, can maintain the system time for the various processing modules on the movable platform 500. By maintaining the system time locally, the movement controller 501 can ensure that the timing signal is received without unnecessary delay and can avoid potential errors in processing and data transmission. Thus, the system time can be reliable and precise, which is beneficial for performing mission critical tasks. For example, a movement controller can maintain the attitude and position of a UAV in the air, by synchronizing the various movement characteristic information (such as the translational acceleration and rotation speed of the UAV) measured by an inertia measurement unit (IMU) with measurements of the environment by other sensors at different time points.

Alternatively, the system time can be configured based on a timing mechanism on the other processing modules on the movable platform 500. For example, a timer can be configured and/or provided on the sensing processor 502, which can process the sensing data collected by various sensors, e.g. vision sensors 521-522.

In accordance with various embodiments, the movement controller 501 can generate a triggering signal for perform a sensing operation. Also, the movement controller 501 can generate a timestamp corresponding to the triggering signal based on the maintained system time.

As shown in FIG. 5, a timing controller 513 in the movement controller 501 can generate a triggering signal (e.g. an exposure signal) in a predetermined frequency based on the configured system time provided by the timer 511. Furthermore, the timing controller 513 can latch the timing signal to generate a timestamp corresponding to the triggering signal, e.g. at the time when the triggering signal is generated. Alternatively, a timestamp can be generated for indicating a predetermined future time point, when multiple sensing operations can be performed simultaneously. For example, the timing controller, which comprises a functional circuit unit, can record a sequence number associated with the latched timing signal 531. Then, the timing controller 513 can save the timestamp corresponding to the triggering signal.

In accordance with various embodiments, the triggering signal can be generated at a predetermined frequency. For example, a movement controller for a UAV can generate an exposure signal for capturing images via the vision sensors 521-522 at a frequency that satisfies the need for controlling a UAV. In some instances, the frequency for generating the exposure signal can be determined or configured to enable the data fusion of vision data with the movement characteristic data collected by the IMU 512. For example, a movement controller for a UAV can generate an exposure signal about or more frequently than every hour, every minute, every thirty seconds, every twenty seconds, every ten seconds, every five seconds, every two seconds, or every second. Or, in every second, a movement controller for a UAV can generate about one, two, five, ten, twenty, thirty, fifty, one hundred, two hundreds, three hundreds, five hundreds, one thousand or more exposure signals.

Furthermore, the timing controller 513 can provide the exposure signal 533 and the timestamp 532 to the sensing processor 502 to trigger the capturing of one or more images by the vision sensors 521-522. In accordance with various embodiments, the movement controller 501 can transmit the exposure signal 533 and the corresponding timestamp 532 to the sensing processor, e.g. via a signal line. Additionally or optionally, the timing controller 513 can encode the timestamp before transmitting to the timestamp information to the sensing processor 502. Once the sensing processor receives the encoded timestamp, the sensing processor 502 can decode the received timestamp information to obtain the timestamp.

In accordance with various embodiments, upon receiving the triggering signal 533 and the corresponding timestamp 532 from the movement controller 501, the sensing processor 502 can trigger the sensing operation by one or more sensors 521-522, obtain sensing data of the triggered sensing operation, and associate the received timestamp with the sensing data. For example, the sensing processor 502 can trigger the one or more vision sensors 521-522 to capture one or more images, which can be used for computing a depth map or performing visual odometry that is useful for positioning, mapping, and obstacle avoidance.

In accordance with various embodiments, the sensing processor 502 can communicate the sensing data with other processing modules on the movable platform 500 via a connection 534 (e.g. a memory bus). Using a memory bus, a large quantity of sensing data can be reliably and efficiently communicate to other processing modules. For example, the sensing processor 502 can write the captured imaging information and/or processed information, such as the vision data applied with the timestamp, into a double data rate synchronous dynamic random-access memory (DDR DRAM) via the memory bus. Additionally, the sensing processor 502 can provide the memory address to the movement controller 501. Then, the movement controller 501 can read the vision data applied with the timestamp out from the corresponding memory block in the DDR DRAM, via the memory bus.

In accordance with various embodiments, the movement controller 501 can make determinations on task and navigation control for the movable platform 500. Furthermore, the movement controller 501 can receive sensing information from other sensors, e.g. IMU sensors 512 on the movement controller 501. In some instances, data from the sensors 512 may be collected at a time point that is different from the time point when the vision data is captured. Based on the timestamp difference, the movement controller 501 can perform data fusion using various technique to synchronize the collected sensing information, e.g. modifying the collected sensing data to compensate for the time difference. Alternatively, data from the other sensors may be collected at a time point that is the same as the time point when the vision data is captured, e.g. at a predetermined time point. Thus, based on the synchronized information, the movement controller 501 can control the navigation, such as planning a complex navigation route for performing multiple tasks simultaneously, e.g. tracking a target while performing obstacle avoidance, and provide such determination to the movement controller 501.

Then, the movement controller 501 can generate control signals 535 for controlling one or more propulsion units 503 based on such determination. For example, a movement controller for a UAV can generate signals to electronic speed controls (ESCs) for controlling the movement of the UAV, via controlling the operation of the propellers. In some instances, an ESC is an electronic circuit with the purpose to vary an electric motor's speed. Thus, by coupling the movement controller 501 and the sensing processor 502 directly, the movable platform 500 can achieve simplicity and reliability.

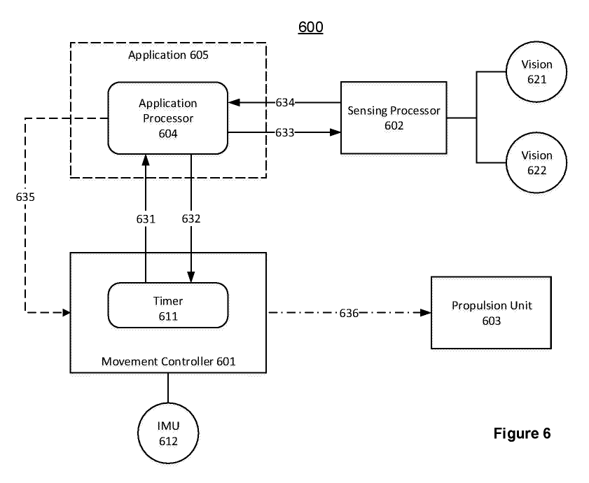

FIG. 6 shows an exemplary illustration of supporting synchronization in another alternative movable platform, in accordance with various embodiments of the present disclosure. As shown in FIG. 6, a movement controller 601 can be used for controlling the movement of a movable platform 600 (e.g. a UAV). Furthermore, the movable platform 600 can use a sensing processor 602 for processing information of the environment. For example, the sensing processor 602 can be a vision processor, e.g. a vision processing unit (VPU), which can process image information of the environment captured by various vision sensors 621-622.

In accordance with various embodiments, the movable platform 600 can be used for maintaining system time. As shown in FIG. 6, the movable platform 600 can maintain a system time based on a timer 611. In some instances, the timer 611 can be configured and/or provided on the movement controller 601. Alternatively, the system time can be configured based on a timing mechanism on the application processor 604 or other processing modules on the movable platform 600.

In accordance with various embodiments, the movement controller 601 can generate a triggering signal. In accordance with various embodiments, the triggering signal can be generated at a predetermined frequency. For example, the frequency for generating the exposure signal can be determined or configured to satisfy the need for controlling a UAV. Additionally, the movement controller can generate the exposure signal for capturing images via the vision sensors 621-622 at a frequency that can enable data fusion of vision data with the inertia data collected by the IMU 612.

Furthermore, the movement controller 601 can provide the triggering signal 631 to the application processor 604 for performing a sensing operation to the application processor 604. Upon receiving the triggering signal, the application processor 604 can generate a timestamp corresponding to the triggering signal based on the maintained system time. The application processor 604 can generate the timestamp based on a local timer or a system time received from another processing module, e.g. the timer 611. Then, the application processor 604 can provide the triggering signal 633 and the timestamp 634 to the sensing processor 602 to trigger the capturing of one or more images by the vision sensors 621-622. Additionally, the application processor 604 can provide the timestamp 632 to the movement controller 601.

In accordance with various embodiments, upon receiving the triggering signal and the corresponding timestamp from the application processor 604, the sensing processor 602 can trigger the sensing operation by one or more sensors 621-622. Then, the sensing processor 602 can obtain sensing data for the triggered sensing operation, and process and associate the received timestamp with the sensing data. For example, the sensing processor 602 can trigger the one or more vision sensors 621-622 to capture one or more images. Then, the sensing processor 602 can compute a depth map or performing visual odometry that is useful for positioning, mapping, and obstacle avoidance.

In accordance with various embodiments, the sensing processor 602 can communicate the sensing data with other processing modules on the movable platform 600 via a connection 634 (e.g. a memory bus). For example, the sensing processor 602 can write the captured imaging information and/or processed information, such as the vision data applied with the timestamp, into a double data rate synchronous dynamic random-access memory (DDR DRAM) via the memory bus. Then, the application processor 604 can obtain the vision data applied with the timestamp from the corresponding memory block in the DDR DRAM, via the memory bus.

In accordance with various embodiments, the application processor 604 can make determinations on UAV task and navigation control. Furthermore, the application processor 604 can receive sensing information from other sensors (including sensors associated with other processing modules, e.g. IMU sensors 612 on the movement controller 601). In some instances, data from the other sensors may be collected at a time point that is different from the time point when the vision data is captured. Based on the timestamp difference, the application processor 604 can perform data fusion using various technique to synchronize the collected sensing information, e.g. modifying the collected sensing data to compensate for the time difference. Alternatively, data from the other sensors may be collected at a time point that is the same as the time point when the vision data is captured, e.g. at a predetermined time point. Thus, based on the synchronized information, the application processor 604 can apply various application logics, such as planning a complex navigation route for performing multiple tasks simultaneously (e.g. tracking a target while performing obstacle avoidance, and provide such determination to the movement controller 601).

Then, the application processor 604 can provide the determination to the movement controller 601 via a connection 635. Thus, the movement controller 601 can generate control signals 636 for controlling one or more propulsion units 603 based on such determination. For example, a movement controller for a UAV can generate signals to electronic speed controls (ESCs) for controlling the movement of the UAV, via controlling the operation of the propellers. In some instances, an ESC is an electronic circuit with the purpose to vary an electric motor's speed.

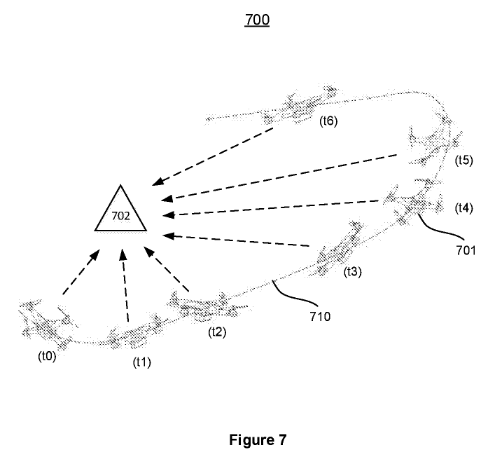

FIG. 7 shows an exemplary illustration of controlling movement of a UAV based on data fusion, in accordance with various embodiments of the present disclosure. The movement of a movable platform, such as a UAV 701, can be controlled to move along a flight path 710. As shown in FIG. 7, the UAV 701 can be at different locations with different attitude at different time points (t0-t6) while circling around a target 702.

In some instances, a movement controller for the UAV 701 can comprise a timer configured to maintain a system time. Additionally, the movement controller can comprise a timer controller configured to generate a triggering signal for an exposure operation and obtain a timestamp corresponding to the triggering signal according to the system time. Furthermore, the UAV 701 can comprise a visual sensing processor associated with one or more image sensors. Upon receiving the triggering signal and the timestamp from the movement controller, the visual sensing processor can direct the one or more image sensors to perform the exposure operation to acquire vision data of surrounding environment, and associate the timestamp with the vision data.

In some instances, the UAV 701 can comprise various processing modules, such as an application processor. The application processor can perform, based on the timestamp, a synchronization of the image data acquired by the one or more image sensors and attitude data acquired by an inertia measurement unit (IMU) associated with the movement controller. Thus, the movement controller can generate one or more control signals for the one or more propulsion units to effect a movement of the UAV in the surrounding environment based on the synchronization of the image data and attitude data.

In accordance with various embodiments, the UAV 701 can support synchronization among multiple processing modules and perform data fusion. For example, an IMU on board the UAV 701 can measure the attitude of the UAV 701 while one or more imaging sensors carried by the UAV 701 can capture images of the surrounding environment (e.g. a target 702) for providing feedbacks to the movement controller. The UAV 701 can take advantage of the flight attitude information collected by an IMU on board the UAV 701 and imaging information collected by vision sensors carried by the UAV 701. Also, the UAV 701 can take advantage of other sensing information such as the location information collected by the global positioning system (GPS) or other similar systems. Thus, in the example as shown in FIG. 7, the UAV 701 can promptly and precisely evaluate the location, attitude of the UAV 701, as well as its relative location to any obstacles or target (e.g. 702) in the circling environment.

In some instances, in order to perform data fusion, data from the IMU may be collected at a time point that is different from the time point when the vision data is captured. Based on the timestamp difference, a processing module, such as the application processor, can perform data fusion using various techniques to synchronize the collected sensing information. For example, the processing module can modify the collected sensing data to compensate for the time difference. Alternatively, sensing data from multiple source can be collected at the same time point, e.g. at a predetermined time point when the vision data is captured. Thus, based on the synchronized information, the processing module can apply various application logics, such as planning a complex navigation route for performing multiple tasks simultaneously (e.g. tracking a target while performing obstacle avoidance, and provide such determination to the movement controller).

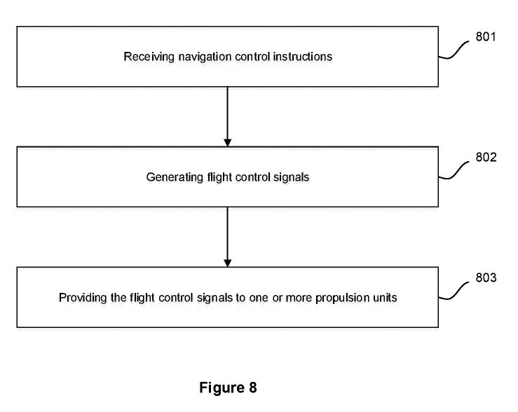

FIG. 8 shows a flowchart of supporting synchronization in a movable platform using a movement controller, in accordance with various embodiments of the present disclosure. As shown in FIG. 8, at step 801, the movement controller can receive navigation control instructions from another processing module or a remote device. Furthermore, at step 1002, the movement controller can generate flight control signals. Then, at step 803, the movement controller can provide the flight control signals to one or more propulsion units.

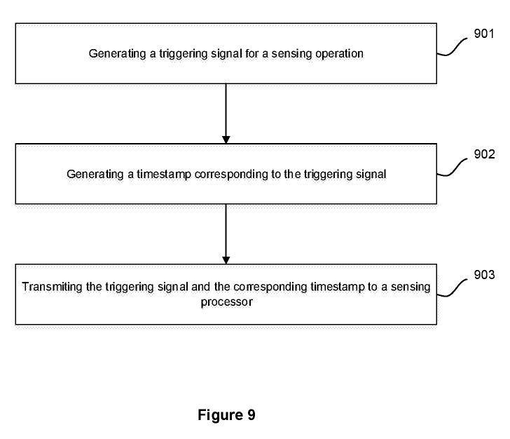

FIG. 9 shows a flowchart of supporting synchronization in a movable platform using a timing controller associated with a movement controller, in accordance with various embodiments of the present disclosure. As shown in FIG. 9, at step 901, the timing controller can generate a triggering signal for a sensing operation. Furthermore, at step 902, the timing controller can generate a timestamp corresponding to the triggering signal. Then, at step 903, the timing controller can transmit the triggering signal and the corresponding timestamp to the sensing processor.

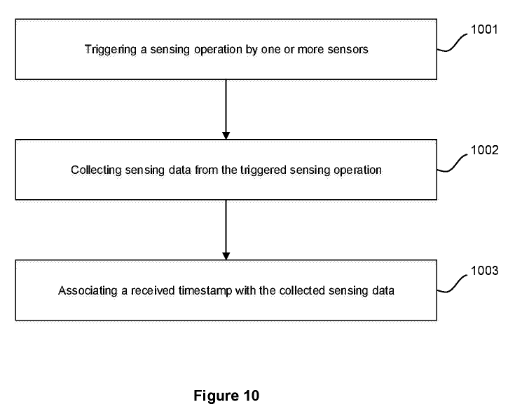

FIG. 10 shows a flowchart of supporting synchronization in a movable platform using a sensing processor, in accordance with various embodiments of the present disclosure. As shown in FIG. 10, at step 1001, upon receiving the triggering signal and the corresponding timestamp from a movement controller, the sensing processor can trigger the sensing operation by one or more sensors. Furthermore, at step 1002, the sensing processor can collect sensing data from the triggered sensing operation. Then, at step 1003, the sensing processor can associate the received timestamp with the collected sensing data.

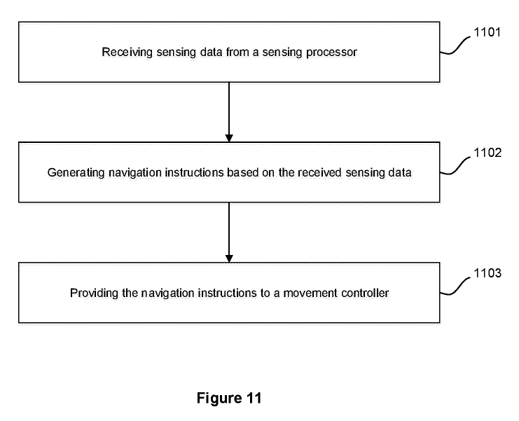

FIG. 11 shows a flowchart of supporting synchronization in a movable platform using an application processor, in accordance with various embodiments of the present disclosure. As shown in FIG. 11, at step 1101, the application processor can receive the sensing data, which may be associated with a timestamp corresponding to a triggering signal, from a sensing processor. Furthermore, at step 1102, the application processor can generate one or more navigation instructions based on the received sensing data. Then, at step 1103, the application processor can provide the one or more navigation instructions to the movement controller.

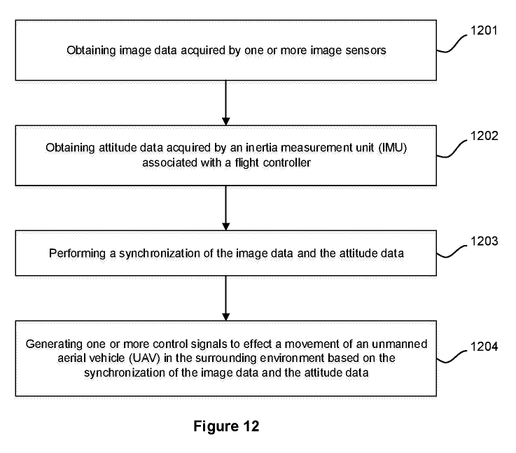

FIG. 12 shows a flowchart of supporting synchronization in a UAV, in accordance with various embodiments of the present disclosure. As shown in FIG. 12, at step 1201, a movement controller for the UAV can obtain image data acquired by one or more image sensors. At step 1202, the movement controller can obtain attitude data acquired by an IMU associated with a movement controller. Furthermore, at step 1203, the movement controller can perform a synchronization of the image data acquired by the one or more image sensors and attitude data acquired by an IMU associated with the movement controller. Then, at step 1204, the movement controller can generate one or more control signals for the one or more propulsion units to effect a movement of the UAV in the surrounding environment based on the synchronization of the image data and attitude data.

Many features of the present disclosure can be performed in, using, or with the assistance of hardware, software, firmware, or combinations thereof. Consequently, features of the present disclosure may be implemented using a processing system (e.g., including one or more processors). Exemplary processors can include, without limitation, one or more general purpose microprocessors (for example, single or multi-core processors), application-specific integrated circuits, application-specific instruction-set processors, graphics processing units, physics processing units, digital signal processing units, coprocessors, network processing units, audio processing units, encryption processing units, and the like.

Features of the present disclosure can be implemented in, using, or with the assistance of a computer program product which is a storage medium (media) or computer readable medium (media) having instructions stored thereon/in which can be used to program a processing system to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the machine readable medium (media), features of the present disclosure can be incorporated in software and/or firmware for controlling the hardware of a processing system, and for enabling a processing system to interact with other mechanism utilizing the results of the present disclosure. Such software or firmware may include, but is not limited to, application code, device drivers, operating systems and execution environments/containers.

Features of the disclosure may also be implemented in hardware using, for example, hardware components such as application specific integrated circuits (ASICs) and field-programmable gate array (FPGA) devices. Implementation of the hardware state machine so as to perform the functions described herein will be apparent to persons skilled in the relevant art.

Additionally, the present disclosure may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

While various embodiments of the present disclosure have been described above, it should be understood that they have been presented by way of example, and not limitation. It will be apparent to persons skilled in the relevant art that various changes in form and detail can be made therein without departing from the spirit and scope of the disclosure.

The present disclosure has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the disclosure.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the invention be defined by the following claims and their equivalence.

What is claimed is:

1. A system for supporting synchronization in a movable platform, comprising:
a sensing processor associated with one or more sensors; and
a timing controller associated with a movement controller, wherein the timing controller operates to:
generate a triggering signal for a sensing operation;
generate a timestamp corresponding to the triggering signal; and
transmit the triggering signal and the timestamp to the sensing processor,
wherein, upon receiving the triggering signal and the timestamp from the movement controller, the sensing processor operates to:
trigger the sensing operation by the one or more sensors;
obtain sensing data of the sensing operation; and
associate the timestamp with the sensing data.

2. The system of claim 1, further comprising:
an application processor that operates to:
receive the sensing data, which is associated with the timestamp corresponding to the triggering signal, from the sensing processor;
generate one or more navigation instructions based on the sensing data; and
provide the one or more navigation instructions to the movement controller.

3. The system of claim 2, wherein the sensing processor operates to communicate the sensing data with the application processor via a memory bus.

4. The system of claim 1, wherein the sensing processor operates to:
receive the triggering signal and the timestamp via a signal line; and
provide the sensing data to another processing module via a memory bus.

5. The system of claim 4, wherein the another processing module is the movement controller, and wherein the movement controller operates to use the timestamp to synchronize the sensing data received from the sensing processor with attitude data collected by one or more inertia measurement unit (IMU) associated with the movement controller.

6. The system of claim 1, wherein the triggering signal is generated at a predetermined frequency.

7. The system of claim 1, wherein the timestamp is generated based on a system time.

8. The system of claim 7, wherein the system time is configured based on a timer associated with the movement controller.

9. The system of claim 1, wherein the one or more sensors comprise vision sensors, and the sensing data comprise image data captured by the vision sensors.

10. The system of claim 9, wherein the sensing processor operates to generate a depth map based on the image data captured by the vision sensors.

11. The system of claim 1, wherein the timing controller operates to latch and save the timestamp corresponding to the triggering signal.

12. The system of claim 1, wherein the timing controller operates to encode the timestamp to obtain encoded timestamp and transmit the encoded timestamp to the sensing processor.

13. The system of claim 12, wherein the sensing processor operates to decode the encoded timestamp to obtain the timestamp.

14. The system of claim 1, wherein the triggering signal and the timestamp are transmitted to the sensing processor via an application processor.

15. The system of claim 14, wherein the application processor operates to communicate with the sensing processor and the movement controller using one or more communication interfaces.

16. The system of claim 1, wherein the sensing processor and the movement controller are included in one of an application-specific integrated circuit (ASIC) or a field programmable gate array (FPGA).

17. The system of claim 1, wherein the sensing processor and the movement controller are included in a system on chip (SoC) or a system in package (SiP).

18. A method for supporting synchronization in a movable platform, comprising:
generating, via a timing controller associated with a movement controller, a triggering signal for a sensing operation;
generating a timestamp corresponding to the triggering signal;
transmitting the triggering signal and the timestamp to a sensing processor;
upon receiving the triggering signal and the timestamp from the movement controller, triggering, via the sensing processor, the sensing operation by one or more sensors;
obtaining sensing data of the triggered sensing operation; and
associating the timestamp with the sensing data.

19. An unmanned aerial vehicle (UAV), comprising:
one or more propulsion units;
a movement controller comprising:
a timer configured to maintain a system time; and
a timing controller configured to:
generate a triggering signal for an exposure operation; and
obtain a timestamp corresponding to the triggering signal according to the system time;
a visual sensing processor associated with one or more image sensors, wherein, upon receiving the triggering signal and the timestamp from the movement controller, the visual sensing processor operates to:
direct the one or more image sensors to perform the exposure operation and to acquire vision data of surrounding environment; and
associate the timestamp with the vision data; and
an application processor, wherein the application processor operates to perform, based on the timestamp, a synchronization of image data acquired by the one or more image sensors and attitude data acquired by an inertia measurement unit (IMU) associated with the movement controller,
wherein the movement controller operates to generate one or more control signals for the one or more propulsion units to effect a movement of the UAV in the surrounding environment based on the synchronization of the image data and the attitude data.

20. The UAV of claim 19, further comprising:
an application processor that operates to:
receive the image data, which is associated with the timestamp corresponding to the triggering signal, from the visual sensing processor;
generate one or more navigation instructions based on the sensing data; and
provide the one or more navigation instructions to the movement controller.
